(19) United States
(12) Patent Application Publication
(10) Pub. No.: US 2026/0346857 A1
(43) Pub. Date: Nov. 5, 2026

(54) MULTIPLE SYSTEMS ON CHIP ARRANGEMENT FOR THE HIGHEST LEVEL OF RELIABILITY, CAR AUTONOMY, ROBOTICS, AVIONICS, AND AEROSPACE

(71) Applicant: Francois Charles Piednoel, Santa Clara, CA (US)

(72) Inventor: Francois Charles Piednoel, Santa Clara, CA (US)

(21) Appl. No.: 19/666,360

(22) Filed: May 4, 2026

Related U.S. Application Data
(60) Provisional application No. 63/799,369, filed on May 3, 2025.

(51) Int. Cl. B60W 50/02; B60W 60/00; G06F 9/4401; G06F 15/78

(52) U.S. Cl. CPC B60W 50/0205; B60W 60/001; G06F 9/4401; G06F 15/7807

(57) ABSTRACT

A computing system including a first system on a chip (SoC) and a second SoC is disclosed. The first SoC includes a first memory and is configured to publish state information corresponding to a set of tasks performed by the first SoC. The second SoC includes a second memory and has memory access to the first memory to dynamically read the state information published by the first SoC. The second SoC is configured to detect a trigger based on the state information and activate a subset of its computational components to take over the set of tasks. The first SoC and the second SoC are further configured to switch roles with respect to execution of the set of tasks and access to the state information.

### CROSS-REFERENCE TO RELATED APPLICATION

This application claims the benefit of the U.S. Provisional Patent Application No. 63/799,369 filed on May 3, 2025, the contents of which are incorporated by reference herein.

### TECHNICAL FIELD

The present disclosure relates generally to computing systems and architectures, and more particularly to systems and methods for providing fault-tolerant and high-reliability operation using multiple system-on-chip (SoC) devices.

### BACKGROUND

Modern computing systems deployed in safety-critical and high-reliability environments often require continuous and dependable operation. These systems include autonomous vehicles, robotics, aerospace systems, and other advanced control systems. These systems typically execute complex, real-time tasks including sensor data processing, perception, inference, decision-making, and control. Failure or interruption in such tasks can lead to significant safety risks and system instability.

To address reliability concerns, conventional systems often employ redundancy techniques, such as duplicating processors, implementing lockstep execution, or using backup controllers. In lockstep architecture, multiple processors execute the same instructions simultaneously and compare outputs to detect discrepancies. Other systems rely on checkpointing mechanisms, where the system state is periodically saved and restored upon failure. While these approaches provide certain levels of fault detection and recovery, they introduce limitations, including increased power consumption, inefficient use of computational resources, and latency associated with restarting or recomputing tasks.

In recent system-on-chip (SoC) architectures, multiple heterogeneous computational components, such as central processing units, machine learning accelerators, memory units, and sensor interfaces, are integrated to improve performance and efficiency. However, such architectures introduce additional complexity and potential failure points, particularly when components operate independently or under varying workloads. Existing redundancy mechanisms do not fully leverage the distributed nature of these architectures to provide fine-grained monitoring or rapid failover at the component level.

Furthermore, many existing systems rely on centralized monitoring or safety controllers to detect faults and manage failover operations. Such centralized approaches can become bottlenecks and may themselves represent single points of failure. Additionally, traditional systems cannot often seamlessly transfer execution of ongoing tasks between processing units without interruption or loss of intermediate computational state.

In advanced applications such as autonomous systems, computational tasks are often performed using complex and sometimes non-deterministic models, including machine learning-based inference engines. These systems must operate reliably under diverse and unpredictable conditions. However, ensuring functional safety and meeting certification standards, such as automotive safety integrity level (ASIL) requirements, remains challenging due to the dynamic and distributed nature of these computations. Accordingly, there is a need for improved computing architectures that provide enhanced fault tolerance, real-time monitoring, and seamless failover capabilities. There is a need in the art for ongoing research and development in this field.

### SUMMARY

The disclosed subject matter relates to a computing system that implements a multiple System-on-Chip (mSoC) architecture to provide redundancy, increase wear life of hardware components, and increase the safety integrity rating of the computing system. The system includes a first SoC comprising a first memory in which the first SoC publishes state information corresponding to a set of tasks being performed by the first SoC. The first SoC further includes a plurality of computational components, comprising various chiplets implementing the set of tasks. The computing system further includes a second SoC comprising a second memory and a second plurality of computational components. The second SoC has direct memory access to the first memory of the first SoC to dynamically read the state information published by the first SoC.

In some embodiments, the second SoC maintains a subset of the second plurality of computational components in a low power state. When the second SoC detects a trigger while reading the state information published in the first memory of the first SoC, the second SoC powers the subset of computational components to perform the set of tasks. In this architecture, the functional safety (FuSa) memory is distributed across the chiplets of each SoC instead of being centralized in a single component. Each chiplet includes a dedicated FuSa memory segment that publishes localized state information relevant to the function it performs. This distributed FuSa memory architecture allows both SoCs to independently monitor the state of each chiplet across the system at a granular level and respond to localized failures while maintaining compliance with safety integrity levels.

In certain embodiments, the set of tasks comprises autonomous system tasks, including sensor data processing, inference, scene understanding, object detection and classification, motion prediction of dynamic external agents, and motion planning and execution to operate an autonomous system along a trajectory. The state information published by the first SoC includes information required for the second SoC to perform the set of autonomous tasks. In some examples, the state information comprises statistical information corresponding to a surrounding environment of the autonomous system in which the computing system resides. Multiple SoC pairs may be implemented, with each pair performing a subset of the autonomous tasks. For example, one SoC pair may perform object detection tasks, a second SoC pair may perform object classification tasks, and a third SoC pair may perform motion prediction tasks. The system may also be implemented in semi-autonomous systems, such as advanced driver assistance systems (ADAS), including collision warning, emergency braking, lane following, lane centering, emergency maneuvering, and automated parking.

In some embodiments, the trigger for performing the set of tasks by the second SoC corresponds to the first SoC experiencing a fault or failure. As provided herein, the fault or the failure experienced by the first SoC can correspond to overheating, power surges, and/or errors in the first SoC. When the second SoC powers the subset of computational components from a low power state and performs the set of tasks, the first SoC may reset or reboot its computational components to attempt to resolve the fault(s) and/or failure(s). Upon resetting or rebooting, the first SoC assumes a backup role relative to the second SoC. That is, the first SoC can directly access the memory of the second SoC to continuously read state information corresponding to the second SoC performing the set of autonomous driving tasks, while the second SoC performs the set of autonomous tasks and publishes state information corresponding to the set of autonomous tasks in its memory.

In certain embodiments, the first SoC can be powered by a first power source of the system, and the second SoC can be powered by a second power source of the system that is largely isolated from the first power source. For example, an autonomous system can include a battery pack that provides power to electric motors to propel, actuate, or otherwise control the autonomous system, and an auxiliary battery (e.g., a standard 12-volt battery) that powers auxiliary system components. For such an autonomous system, the first SoC may be powered by the battery pack and the second SoC may be powered by the auxiliary battery.

In further examples, the first SoC and the second SoC can be electrically coupled to each other via an interconnect having at least one electrical safety switch (e.g., one or more eFuses) to protect the computing system from power surges from either the first SoC or the second SoC. As such, the first SoC and the second SoC can be electrically isolated from each other. Additionally, each SoC monitors the chiplet-level current drain of the other SoC using current measurement devices and the eFuses themselves, providing real-time fault detection at a chiplet level. Each SoC implements a control mechanism that governs the disengagement or shutdown of the eFuses when anomalous current drain is detected.

In some embodiments, each time the computing system is rebooted, the first SoC and the second SoC switch between primary and backup roles. Accordingly, in normal operation when neither experiences a fault or failure, if the first SoC performs the set of tasks during a first computing session, the second SoC will perform the set of tasks during a second computing session. The backup SoC continuously reads the memory of the primary SoC, with its subset of computational components in a low power state and ready to perform the set of tasks. The primary SoC may also read the memory of the backup SoC to verify readiness and may initiate a reset or reboot of the backup SoC when a fault or failure is detected.

In certain embodiments, the arrangement of the SoC pairs in which a backup SoC dynamically reads state information and performs the set of tasks provides redundancy to support a safety integrity rating for the computing system. The computational components of each SoC comprise chiplets, such as one or more CPU chiplets, autonomous operation chiplets, machine learning (ML) accelerator chiplets, sensor input chiplets, and high bandwidth memory chiplets. Each SoC includes a functional safety (FuSa) CPU configured to publish state information of the SoC to a FuSa component of the SoC's memory. This FuSa memory component remains operational regardless of whether the SoC is in the primary or backup role.

The foregoing is not intended to be an exhaustive list of embodiments and features of the disclosed subject matter. Persons skilled in the art are capable of appreciating other embodiments and features from the following detailed description in conjunction with the drawings.

### BRIEF DESCRIPTION OF THE DRAWINGS

The disclosure herein is illustrated by way of example, and not by way of limitation, in the figures of the accompanying drawings in which like-reference numerals refer to similar elements, and in which:

FIG. 1A is a block diagram depicting an example computing system in which embodiments described herein may be implemented, in accordance with examples described herein.

FIG. 1B is a block diagram depicting an example system architecture of a multiple Systems-on-Chip (mSoC) arrangement illustrating state information sharing between a first SoC and a second SoC, in accordance with examples described herein.

FIG. 2 is a block diagram depicting another example multiple Systems-on-Chip (mSoC), in accordance with examples described herein.

FIG. 3 is a block diagram illustrating another example SoC of a multiple Systems-on-Chip (mSoC) arrangement, in accordance with examples described herein.

FIG. 4 is a block diagram depicting an example central chiplet of a SoC that includes a shared memory device in each chiplet for implementing duplicated status and shadowing for multiple SoCs, according to examples described herein.

FIG. 5 and FIG. 6 are flow charts describing methods of implementing duplicated status and shadowing for multiple SoCs, according to examples described herein.

FIG. 7 is a block diagram illustrating role switching between the first SoC and the second SoC, in accordance with examples described herein.

FIG. 8 is a diagram illustrating state information sharing and transition of execution of a set of tasks from the first SoC to the second SoC, in accordance with examples described herein.

### DETAILED DESCRIPTION

The disclosed subject matter relates to a dual system-on-chip computing arrangement for autonomous machines. The arrangement continues to perform its tasks when one of the two SoCs fails. The continuation does not require a task restart or a reload of working state. One SoC performs the autonomous workload. That SoC continuously publishes a complete copy of its working state into a region of its own memory. The other SoC reads that memory region continuously over an interconnect. The reading SoC maintains a current copy of the working state in its own memory while holding most of its compute components in a low power condition. The reading SoC powers up its components and resumes the workload from the current copy when a fault in the publishing SoC is detected. There is no checkpoint to load and no warm-up of working state. The two SoCs exchange their roles on reboot. The role exchange spreads operating time across the two SoCs and gives each SoC regular periods of reduced load. This system may also be designed to incorporate any number of SoCs and provide redundancies when one or more of them fail.

This arrangement differs from a lockstep execution arrangement because the two SoCs are not synchronized at the instruction level and do not duplicate computation cycle for cycle. The arrangement therefore provides the throughput of two SoCs over the service life of the system rather than the throughput of one. The arrangement differs from a checkpointing arrangement because the working state is published continuously and is current at the moment of any fault. There is no interval of work between a saved snapshot and the failure that needs to be discarded or repeated. The arrangement differs from a conventional hot-standby arrangement because the reading SoC is not waiting to be loaded with a recovery image. The reading SoC already holds the most recent working state and can resume from it directly.

The set of tasks performed by the publishing SoC includes those carried out by an autonomous compute platform in a vehicle. Examples include sensor data perception, multi-sensor fusion, machine learning inference for object detection and prediction, motion planning, and the issuance of control commands to actuators. The working state shared between the two SoCs is the information that allows the reading SoC to continue these tasks at the moment of takeover. Examples of state information include the context of running programs, the contents of registers and queues, the parameters and intermediate outputs of machine learning models in use, recent statistics describing the surrounding environment of the vehicle, and health and status information for the publishing SoC and its components.

The first SoC and the second SoC each include a plurality of computational components arranged as chiplets. Examples of chiplets include sensor input chiplets, central chiplets, machine learning accelerator chiplets, general compute chiplets, and high-bandwidth memory chiplets. Each SoC includes a functional safety processor and a memory region dedicated to functional safety operations. The functional safety processor of the reading SoC continues to operate while the remaining chiplets of the reading SoC are held in a low-power condition. The functional safety processor of the reading SoC performs the continuous reading of state information from the publishing SoC and detects the trigger that initiates a takeover.

The trigger may correspond to a fault or a failure of the publishing SoC. Examples of a fault or a failure includes overheating of the publishing SoC, a power surge, a memory error, an arithmetic error, a chiplet failure, and a loss of response from the publishing SoC. The interconnect between the two SoCs may include one or more electrical safety switches that isolate one SoC from the other when an electrical anomaly is detected. The two SoCs may be powered by independent power sources to limit the propagation of electrical faults from one SoC to the other.

The continuous role-exchanging arrangement supports a safety and integrity certification for the computing system that includes redundancy of the compute pipeline. The Automotive Safety Integrity Level standard, set forth in ISO 26262, defines four levels from ASIL A to ASIL D. ASIL D is the highest of these levels and applies to functions whose failure can cause severe and uncontrollable harm to vehicle occupants or other road users. The continuous publication and reading of state information, the fast takeover, the per-chiplet electrical fuse protection, and the role exchange on reboot together provide the redundancy and the fault-handling characteristics relevant to an ASIL D rating in autonomous drive computing.

The figures and the description that follows describe specific embodiments of the dual SoC computing system, the methods by which the two SoCs publish and read state information and transfer execution of the set of tasks, and the structures within each SoC that support these operations. The embodiments shown are illustrative. The disclosed subject matter is not limited to these embodiments and extends to combinations and modifications that fall within the scope of the appended claims.

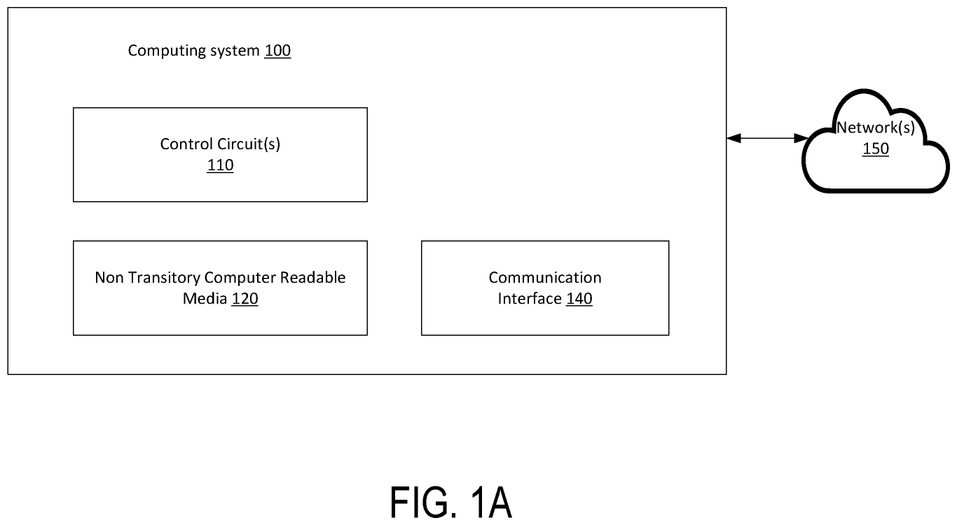

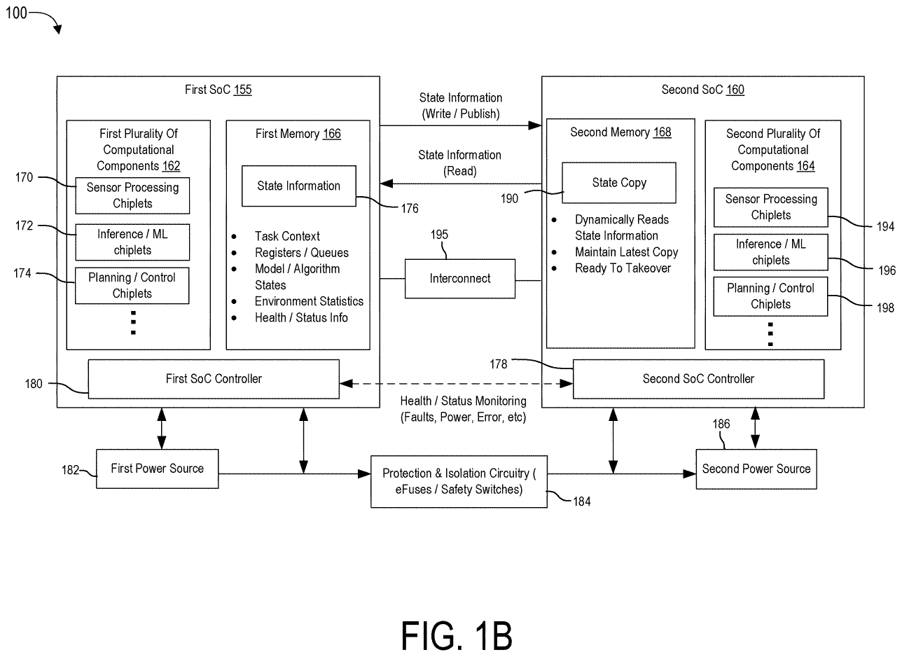

Referring to FIG. 1A, FIG. 1A is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the one or more control circuits 110 and/or computing system 100 may be part of, or may form, a vehicle control unit (also referred to as a vehicle controller) that is embedded or otherwise installed in a vehicle. For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

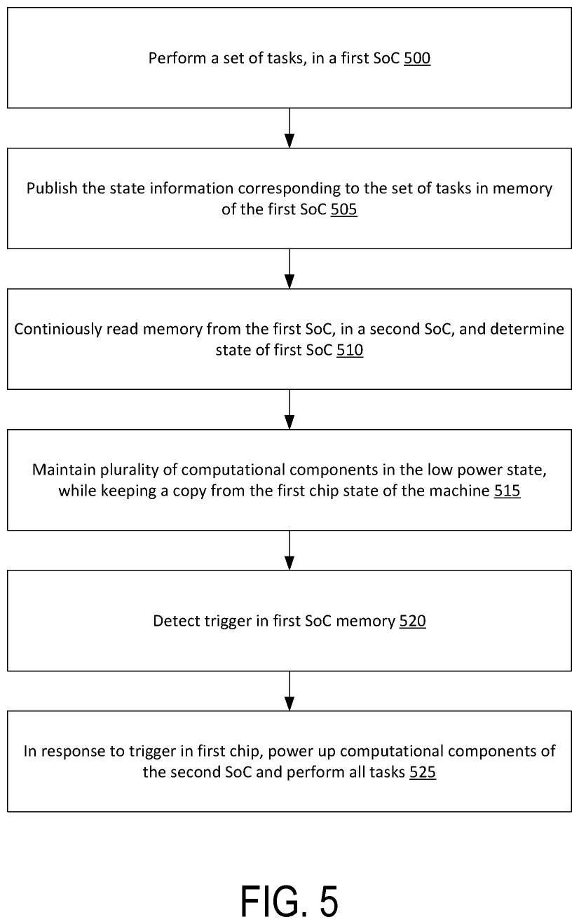

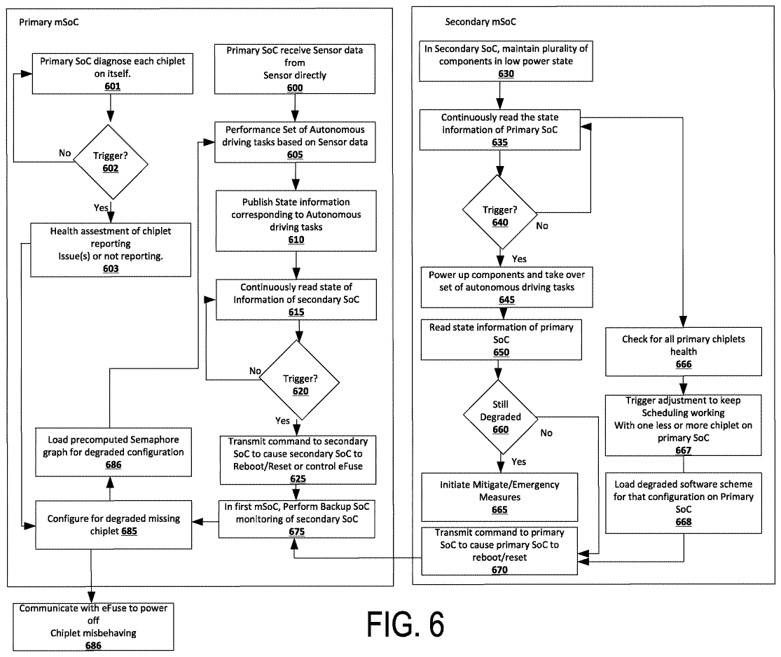

In an embodiment, the one or more control circuits 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 5 and 6.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the one or more control circuits 110 to perform one or more functional tasks. The modules and computer-readable/executable instructions may be described as performing various operations or tasks when the one or more control circuits 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over the one or more networks 150, with other systems using the communication interface 140 to receive sensor data and implement the intersection classification methods described throughout the present disclosure. In certain embodiments, the communication interface 140 may be used to communicate with one or more other systems. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

In an example embodiment, the one or more control circuits 110 of the computing system 100 can include a dual SoC arrangement that facilitates the various methods and techniques described throughout the present disclosure. In various examples, the SoCs can perform a set of tasks in a primary SoC and backup SoC arrangement, where the primary SoC performs the set of tasks, and the backup SoC maintains a standby state and monitors the status and/or state of the primary SoC. In various implementations, the set of tasks can comprise a set of autonomous system tasks, such as perception, object detection and classification, grid occupancy determination, sensor data fusion and processing, motion prediction (e.g., of dynamic external entities), motion planning, and control tasks for autonomously operating a system along a trajectory. As described herein, multiple dual SoC arrangements may be implemented for performing these tasks, with each SoC pair being configured in the manner described in detail below.

Referring to FIG. 1B, FIG. 1B illustrates a block diagram of an example computing system 100 implementing a multiple system-on-chip (mSoC) architecture, in accordance with examples described herein. The computing system 100 includes a first SoC 155 and a second SoC 160. The first SoC 155 and the second SoC 160 are configured to operate in coordination to perform a set of tasks and to provide redundancy in the execution of the set of tasks.

The first SoC 155 comprises a first plurality of computational components 162 and a first memory 166. The first plurality of computational components 162 comprises chiplets including, for example, one or more sensor processing chiplets 170, one or more inference or machine learning (ML) chiplets 172, and one or more planning or control chiplets 174. These chiplets collectively perform the set of tasks. In some embodiments, the set of tasks comprises autonomous system tasks, including sensor data processing, inference, scene understanding, object detection and classification, motion prediction of dynamic external agents, and motion planning and execution to operate an autonomous system along a trajectory.

The first SoC 155 is configured to perform the set of tasks using the first plurality of computational components 162. The first memory 166 stores state information corresponding to the set of tasks performed by the first SoC 155. The first SoC 155 is configured to publish the state information 176 in the first memory 166. In some embodiments, the state information 176 includes task context, registers or queues, model or algorithm states, environment statistics, and health or status information associated with execution of the set of tasks.

The second SoC 160 comprises a second plurality of computational components 164 and a second memory 168. The second plurality of computational components 164 comprise chiplets including one or more sensor processing chiplets 194, one or more inference or machine learning chiplets 196, and one or more planning or control chiplets 198. The second SoC 160 has memory access to the first memory 166 of the first SoC 155 to dynamically read the state information published by the first SoC 155. In some embodiments, the second SoC 160 performs operations including “Dynamically Reads State Information,” “Maintain Latest Copy,” and “Ready To Takeover” with respect to the state information stored in the first memory 166 and the second memory 168.

In some embodiments, the second SoC 160 stores the state information in the second memory 168 and dynamically updates the state information based on reading the state information from the first memory 166. In this manner, the second SoC 160 maintains information corresponding to execution of the set of tasks by the first SoC 155. In some embodiments, the state information stored in the second memory 168 corresponds to a state copy 190 representing the state information 176 read from the first memory 166. In some embodiments, at least a subset of the second plurality of computational components 164 is maintained in a low power state while the second SoC 160 reads the state information.

The first SoC 155 and the second SoC 160 are coupled via an interconnect 195 that enables communication and data transfer between the first SoC 155 and the second SoC 160. The interconnect 195 facilitates transfer of the state information between the first memory 166 and the second SoC 160, and supports memory access by the second SoC 160 to the first memory 166.

In certain implementations, the computing system further includes a first SoC controller 180 associated with the first SoC 155 and a second SoC controller 178 associated with the second SoC 160. The first SoC controller 180 and the second SoC controller 178 are configured to monitor operational status of the respective SoCs. The monitoring may include health and status information such as fault conditions, power conditions, and other error conditions. The first SoC 155 and the second SoC 160 may exchange such monitoring information to determine operational status of each other. In some embodiments, the first SoC controller 180 and the second SoC controller 178 communicate monitoring information via a communication path to enable exchange of health and status information between the first SoC 155 and the second SoC 160.

The computing system further includes a first power source 182 configured to supply power to the first SoC 155 and a second power source 186 configured to supply power to the second SoC 160. In some embodiments, the first power source 182 and the second power source 186 are electrically isolated from each other. The first SoC 155 and the second SoC 160 may be electrically coupled through protection and isolation circuitry 184, which may include one or more electrical safety switches, such as eFuses, to isolate faults and limit effects of electrical anomalies between the first SoC 155 and the second SoC 160.

In exemplary embodiments, the first SoC 155 performs the set of tasks using the first plurality of computational components 162 and publishes the state information in the first memory 166. The second SoC 160 dynamically reads the state information from the first memory 166 and maintains readiness to perform the set of tasks. In some embodiments, the second SoC 160 is configured to detect a trigger based on the state information, where the trigger corresponds to a fault or failure associated with the first SoC 155, including overheating, power conditions, or error conditions.

In response to detecting the trigger, the second SoC 160 activates a subset of the second plurality of computational components 164 to perform the set of tasks. In some embodiments, the first SoC 155 may reset or reboot in response to the fault or failure, while the second SoC 160 performs the set of tasks using the state information.

In further embodiments, the first SoC 155 and the second SoC 160 are configured to switch roles with respect to execution of the set of tasks and access to the state information. For example, after a reboot of the computing system, the second SoC 160 may perform the set of tasks and publish state information in the second memory 168, while the first SoC 155 reads the state information and maintains readiness to perform the set of tasks.

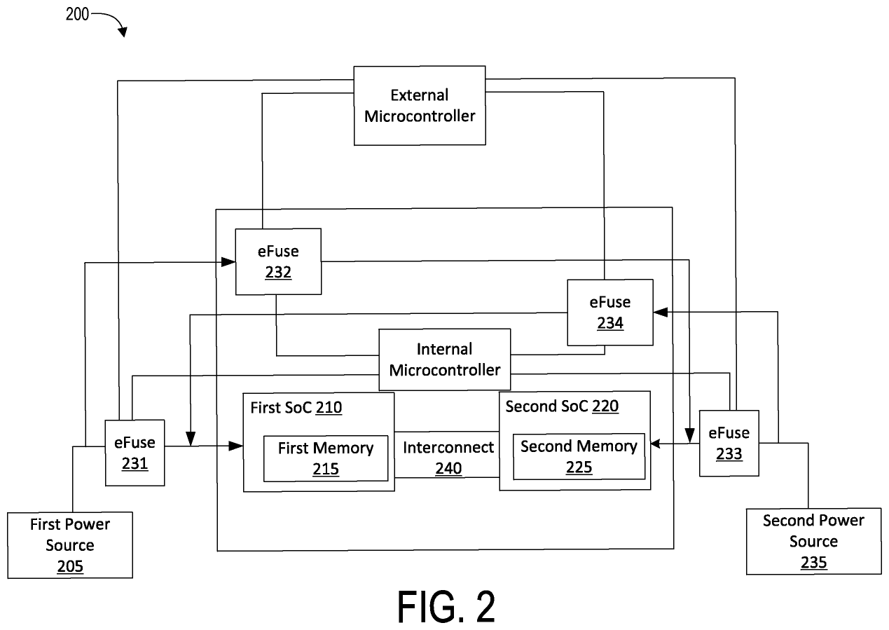

Referring to FIG. 2, FIG. 2 is a block diagram depicting an example computing system 200 implementing a multiple Systems-on-Chip (mSoC), in accordance with examples described herein. In various examples, the computing system 200 can include a first SoC 210 having a first memory 215 and a second SoC 220 having a second memory 225 coupled by an interconnect 240 (e.g., an ASIL-D rated interconnect) that enables each of the first SoC 210 and second SoC 220 to read each other's memories (215, 225). During any given session, the first SoC 210 and the second SoC 220 may alternate roles, between a primary SoC and a backup SoC. As provided herein, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, machine learning (ML) accelerators, and/or memory chiplets) in a low power state, and continuously or periodically read the memory of the primary SoC.

For example, if the first SoC 210 is the primary SoC and the second SoC 220 is the backup SoC, then the first SoC 210 performs a set of autonomous operation tasks and publishes state information corresponding to these tasks in the first memory 215. The second SoC 220 reads the published state information in the first memory 215 to continuously check that the first SoC 210 is operating within nominal thresholds (e.g., temperature thresholds, bandwidth and/or memory thresholds, etc.), and that the first SoC 210 is performing the set of autonomous operation tasks properly. As such, the second SoC 220 performs health monitoring and error management tasks for the first SoC 210, and takes over control of the set of autonomous operation tasks when a triggering condition is met. As provided herein, the triggering condition can correspond to a fault, failure, or other error experienced by the first SoC 210 that may affect the performance of the set of tasks by the first SoC 210.

In various implementations, the second SoC 220 can publish state information corresponding to its computational components being maintained in a standby state (e.g., a low power state in which the second SoC 220 maintains readiness to take over the set of tasks from the first SoC 210). In such examples, the first SoC 210 can monitor the state information of the second SoC 220 by continuously or periodically reading the memory 225 of the second SoC 220 to also perform health check monitoring and error management on the second SoC 220. For example, if the first SoC 210 detects a fault, failure, or other error in the second SoC 220, the first SoC 210 can trigger the second SoC 220 to perform a system reset or reboot.

In certain examples, the first SoC 210 and the second SoC 220 can each include a functional safety (FuSa) component that performs the health monitoring and error management tasks. The FuSa component can be maintained in a powered state for each SoC, whether the SoC operates in a primary or backup manner. As such, the backup SoC may maintain its other components in a low powered state, with its FuSa component being powered up and performing the heath monitoring and error management tasks described herein.

In various aspects, when the first SoC 210 operates as the primary SoC, the state information published in the first memory 215 can correspond to the set of tasks being performed by the first SoC 210. For example, the first SoC 210 can publish any information corresponding to the surrounding environment of the system (e.g., any external entities identified by the first SoC 210, their locations, and predicted trajectories, detected objects, such as traffic signals, signage, lane markings, and crosswalk, and the like). The state information can further include the operating temperatures of the computational components of the first SoC 210, bandwidth usage and available memory of the chiplets of the first SoC 210, and/or any faults or errors, or information indicating faults or errors in these components.

In further aspects, when the second SoC 220 operates as the backup SoC, the state information published in the second memory 225 can correspond to the state of each computational component of the second SoC 220. In particular, these components may operate in a low power state in which the components are ready to take over the set of tasks being performed by the first SoC 210. The state information can include whether the components are operating within nominal temperatures and other nominal ranges (e.g., available bandwidth, power, memory, etc.).

As described throughout the present disclosure, the first SoC 210 and the second SoC 220 can switch between operating as the primary SoC and the backup SoC (e.g., each time the computing system 200 is rebooted). For example, in a computing session subsequent to a session in which the first SoC 210 operated as the primary SoC and the second SoC 220 operated as the backup SoC, the second SoC 220 can assume the role of the primary SoC and the first SoC 210 can assume the role of the backup SoC. It is contemplated that this process of switching roles between the two SoCs can provide substantially even wear of the hardware components of each SoC, which can prolong the lifespan of the computing system 200 as a whole.

According to embodiments, the first SoC 210 can be powered by a first power source 205 and the second SoC 220 can be powered by a second power source 235 that is independent or isolated from the first power source 205. For example, in an electric vehicle, the first power source 205 can comprise the battery pack used for propelling the electric motors of the vehicle, and the second power source 235 can comprise the auxiliary power source of the vehicle (e.g., a 12-volt battery). In other implementations, the first and second power sources (205, 235) can comprise other types of power sources, such as dedicated batteries for each SoC (210, 220) or other power sources that are electrically isolated or otherwise not dependent from each other.

In various implementations, the first SoC 210 and the second SoC 220 may be electrically insulated from each other via a set of one or more eFuses (232, 234), which can be triggered if, for example, a power surge occurs in the system 200. The eFuse 232 and eFuse 234 can comprise a physical fuse (e.g., a microscopic fuse place in the computer chip), a logical fuse consisting of a computer program that trips when current and/or voltage exceeds a specified threshold, or a combination of a physical and logical fuse. In an example scenario, if the second SoC 220 experiences a power surge, eFuse 234 will trip and prevent the same power surge from affecting the first SoC 210. Conversely, if the first SoC 210 experiences a power surge, eFuse 232 will trip and prevent the same power surge from affecting the second SoC 220. Thus, if a power surge occurs, at least one of the SoCs will remain operational (e.g., and operate as the primary SoC), while the SoC that has experienced the power surge can reboot or reset and/or operate as the backup SoC.

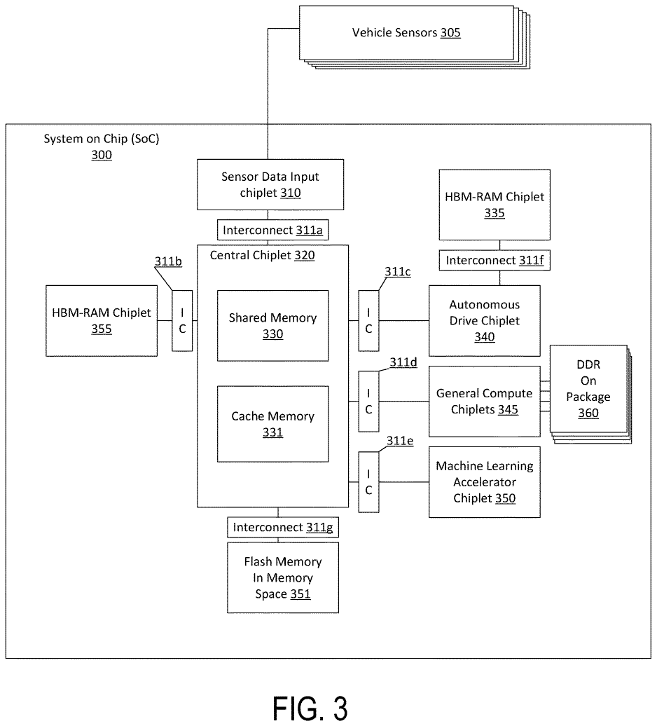

It is contemplated that the multiple Systems-on-Chip (mSoC) arrangement of the computing system 200 can be provided to increase the safety integrity level (e.g., ASIL rating) of the computing system 200 and the overall autonomous driving system of the vehicle. As described herein, the autonomous system can include any number of dual SoC arrangements, each of which can perform a set of autonomous operation tasks. In doing so, the backup SoC dynamically monitors the health of the primary SoC in accordance with a set of functional safety operations, such that when a fault, failure, or other error is detected, the backup SoC can readily power up its components and take over the set of tasks from the primary SoC. A further description of the SoCs and their computational components is provided below with respect to FIG. 3.

FIG. 3 is a block diagram illustrating an example SoC 300, in accordance with examples described herein. The SoC 300 can comprise either the first SoC 210 or the second SoC 220 as shown and described in connection with FIG. 2. Furthermore, the example system on chip 300 shown in FIG. 3 can include additional components, and the components of system on chip 300 may be arranged in various alternative configurations other than the example shown. Thus, the system on chip 300 of FIG. 3 is described herein as an example arrangement for illustrative purposes and is not intended to limit the scope of the present disclosure in any manner.

Referring to FIG. 3, a sensor data input chiplet 310 of the system on chip 300 can receive sensor data from various vehicle sensors 305 of the vehicle. These vehicle sensors 305 can include any combination of image sensors (e.g., single cameras, binocular cameras, fisheye lens cameras, etc.), LIDAR sensors, radar sensors, ultrasonic sensors, proximity sensors, and the like. The sensor data input chiplet 310 can automatically dump the received sensor data as it's received into a cache memory 331 of the central chiplet 320. The sensor data input chiplet 310 can also include an image signal processor (ISP) responsible for capturing, processing, and enhancing images taken from the various vehicle sensors 305. The ISP takes image data and performs a series of complex image processing operations, such as color, contrast, and brightness correction, noise reduction, and image enhancement, to create a higher-quality image that is ready for further processing or analysis by the other chiplets of the SoC 300. The ISP may also include features such as auto-focus, image stabilization, and advanced scene recognition to further enhance the quality of the captured images. The ISP can then store the higher-quality images in the cache memory 331.

In some aspects, the sensor data input chiplet 310 publishes identifying information for each item of sensor data (e.g., images, point cloud maps, etc.) to a shared memory 330 of a central chiplet 320, which acts as a central mailbox for synchronizing workloads for the various chiplets. The identifying information can include details such as an address in the cache memory 331 where the data is stored, the type of sensor data, which sensor captured the data, and a timestamp of when the data was captured.

To communicate with the central chiplet 320, the sensor data input chiplet 310 transmits data through an interconnect 311a. Interconnects 311a-f each represent die-to-die (D2D) interfaces between the chiplets of the SoC 300. In some respects, the interconnects include a high-bandwidth data path used for general data purposes to the cache memory 331 and a high-reliability data path to transmit functional safety and scheduler information to the shared memory 330. Depending on bandwidth requirements, an interconnect may include more than one die-to-die interface. For example, interconnect 311a can include two interfaces to support higher bandwidth communications between the sensor data input chiplet 310 and the central chiplet 320.

In one aspect, the interconnects 311a-f implement the Universal Chiplet Interconnect Express (UCIe) standard and communicate through an indirect mode to allow each of the chiplet host processors to access remote memory as if it were local memory. This is achieved by using a specialized Network on Chip (NoC) Network Interface Unit (NIU) (which allows freedom of interference between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the system on chip 300 can include additional chiplets that can store, alter, or otherwise process the sensor data cached by the sensor data input chiplet 310. The system on chip 300 can include an autonomous drive chiplet 340 that can perform the perception, sensor fusion, trajectory prediction, and/or other algorithms required for the operation of an autonomous system. The autonomous drive chiplet 340 can be connected to a dedicated HBM-RAM chiplet 335 in which the autonomous drive chiplet 340 can publish all status information, variables, statistical information, and/or processed sensor data as processed by the autonomous drive chiplet 340.

In various examples, the system on chip 300 can further include a machine-learning (ML) accelerator chiplet 350 that is specialized for accelerating AI workloads, such as image inferences or other sensor inferences using ML, in order to achieve high performance and low power consumption for these workloads. The ML accelerator chiplet 350 can include an engine designed to efficiently process graph-based data structures, which are commonly used in AI workloads, and a highly parallel processor, allowing for efficient processing of large volumes of data. The ML accelerator chiplet 350 can also include specialized hardware accelerators for common AI operations such as matrix multiplication and convolution as well as a memory hierarchy designed to optimize memory access for AI workloads, which often have complex memory access patterns.

The general compute chiplets 345 can provide general purpose computing for the system on chip 300. For example, the general compute chiplets 345 can comprise high-powered central processing units and/or graphical processing units that can support the computing tasks of the central chiplet 320, autonomous drive chiplet 340, and/or machine learning (ML) accelerator chiplet 350. In some implementations, the system further includes DDR on package 360 coupled to the general compute chiplets 345. The DDR on package 360 provides high-speed memory to support execution of the set of tasks and storage of intermediate computational data.

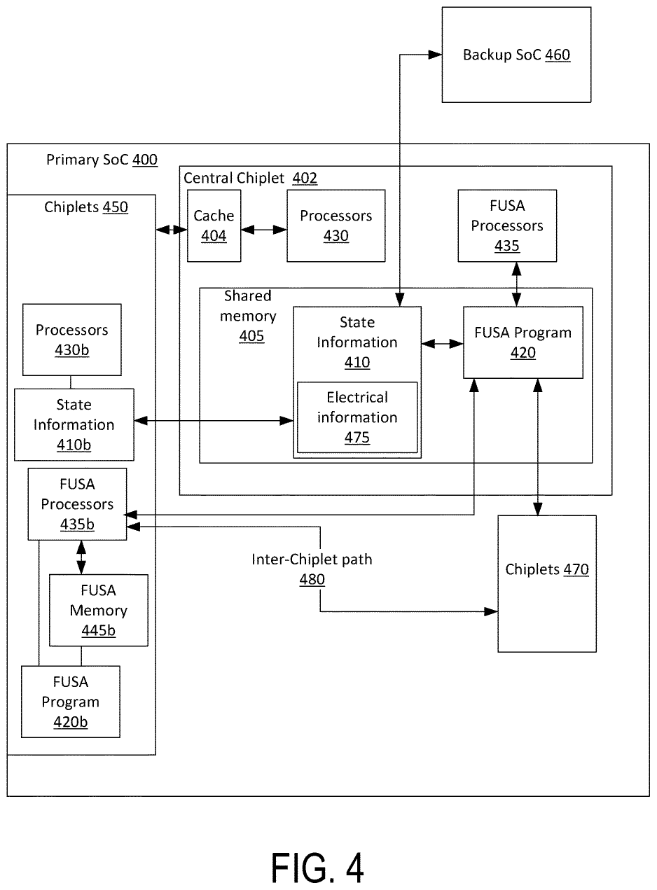

In various implementations, the shared memory 330 can store programs and instructions for performing autonomous operation tasks. The shared memory 330 of the central chiplet 320 can further include a reservation table that provides the various chiplets with the information needed (e.g., sensor data items and their locations in memory) for performing their individual tasks. Further description of the shared memory 330 in the context of the dual SoC arrangements described herein is provided below with respect to FIG. 4. The central chiplet 320 also includes the cache memory 331, which supports invalidate and flush operations for stored data.

Cache misses and evictions from the cache memory 331 are sent by a high-bandwidth memory (HBM) RAM chiplet 355 connected to the central chiplet 320. The HBM-RAM chiplet 355 can include status information, variables, statistical information, and/or sensor data for all other chiplets. In certain examples, the information stored in the HBM-RAM chiplet 355 can be stored for a predetermined period of time (e.g., ten seconds) before deleting or otherwise flushing the data. For example, when a fault occurs on the autonomous system, the information stored in the HBM-RAM chiplet 355 can include all information necessary to diagnose and resolve the fault. Cache memory 331 keeps fresh data available with low latency and less power required compared to accessing data from the HBM-RAM chiplet 355. In some implementations, the central chiplet 320 is further coupled, via interconnect 311g, to a flash memory in memory space 351 configured to store non-volatile data, including firmware, state information, and intermediate computational data to support operation of the system.

In various implementations, the shared memory 330 can house programs and instructions for performing autonomous tasks. The shared memory 330 of the central chiplet 320 can further include a reservation table that provides the various chiplets with the information needed (e.g., sensor data items and their locations in memory) for performing their individual tasks. Further description of the shared memory 330 in the context of the dual SoC arrangements described herein is provided below with respect to FIG. 4.

Referring to FIG. 4, FIG. 4 is a block diagram depicting an example central chiplet 402 of a primary SoC 400 that includes a shared memory 405 for implementing duplicated status and shadowing for multiple SoCs, according to examples described herein. The central chiplet 402 shown in FIG. 4 can correspond to the central chiplet 320 of the SoC 300 as shown and described with respect to FIG. 3. Furthermore, the chiplets 450 shown with respect to FIG. 4 can correspond to one or more of the sensor data input chiplet 310, autonomous drive chiplet 340, general compute chiplets 345, or machine learning (ML) accelerator chiplet 350 of FIG. 3.

As used herein, the terms “primary SoC” and “backup SoC” are used for illustrative purposes to describe operational roles of the system-on-chip devices. It should be understood that the “primary SoC 400” may correspond to the “first SoC,” and the “backup SoC 460” may correspond to the “second SoC,” as described elsewhere in the specification. These designations are interchangeable and may vary depending on operational state, including role switching between the SoCs. Accordingly, the use of “primary” and “backup” does not limit the structural or functional scope of the “first SoC” and “second SoC,” and either SoC may perform the functions attributed to the other.

Referring to FIG. 4, the central chiplet 402 of a primary SoC 400 can include a shared memory 405 that stores state information 410 published by a set of processors 430 of the central chiplet 402 as well as the chiplets 450 of the primary SoC 400. In addition, state information 410b can be generated by processors 430b of the backup SoC 460. In various examples, the set of processors 430 and the chiplets 450 perform the set of tasks (e.g., autonomous operation tasks) and publish state information 410 corresponding to those tasks in the shared memory 405 of the central chiplet 402. Additionally, or alternatively, the set of processors 430 and the chiplets 450 can publish the state information 410 corresponding to the set of tasks in a cache 404 of the central chiplet. As provided herein, the state information 410 can comprise any information needed for a backup SoC 460 to take over the set of tasks. This can include statistical information corresponding to the surrounding environment of the autonomous system (e.g., the last images from cameras, last datasets from other sensors, classified objects, their locations, localization information, etc.), as well as performance data of the hardware components of the primary SoC 400 (e.g., bandwidth, temperature, memory information). In some implementations, the state information 410 includes electrical information 475 corresponding to operational parameters of one or more components of the SoC. The backup SoC 460 can have access to the shared memory 405 as well as the cache 404 of the central chiplet 402 to obtain the state information 410 and necessary datasets for seamlessly taking over the autonomous driving tasks from the primary SoC 400. In further examples, the backup SoC 460 can include a sensor data input chiplet that has direct data access to the sensor set of the autonomous system. When the backup SoC 460 takes over the primary role from the primary SoC 400, the sensor data input chiplet is initiated to obtain real-time sensor data from the autonomous system's sensors to continue the autonomous operation tasks.

In various examples, the shared memory 405 can include a functional safety (FuSa) program 420 that performs health monitoring and error management operations for the primary SoC 400 as well as the backup SoC 460. Likewise, the backup SoC 460 can also include a set of chiplets and a central chiplet with a shared memory (or cache) in which the components of the backup SoC 460 publish state information 410b. The central chiplet of the backup SoC 460 can further include FuSa components for performing health monitoring and error management tasks for the backup SoC 460, as well as having direct memory access to the state information 410 of the primary SoC 400. In certain examples, the FuSa components can include a dedicated FuSa processor 435 to execute the FuSa program 420 and perform the health monitoring and error management functions described throughout the present disclosure. Similarly, the backup SoC 460 can include a FuSa processor 435b configured to execute a FuSa program 420b.

In various implementations, the FuSa program 420 of the primary SoC 400 can access the shared memory of the backup SoC 460 to dynamically read the state information of the backup SoC 460. In further implementations, the FuSa program of the backup SoC 460 can access and dynamically read the state information 410 in the shared memory 405 of the primary SoC 400. When a triggering event occurs (e.g., a fault or failure), as detected in the state information 410 by the FuSa program of the backup SoC 460, the backup SoC 460 can take over the set of tasks being performed by the primary SoC 400. Thereafter, the primary SoC 400 may reboot or reset the component(s) experiencing the fault or failure, or can reboot or reset the primary SoC 400 itself, and assumes the role of backup SoC.

In such implementations, the primary SoC 400 can power down the chiplets 450 and/or the processors 430 of the central chiplet 402 and can maintain the powered-up state for the FuSa processor 435 to execute the FuSa program 420 and monitor the state information published by the SoC 460 in its own shared memory or cache. Accordingly, in autonomous applications, the autonomous tasks previously performed by the primary SoC 400, can be seamlessly transferred to the backup SoC 460 when the triggering event in the state information 410 is detected by the backup SoC 460. In addition, a FuSa memory 445b is distributed across one or more of the chiplets 450 and configured to store a synchronized copy of the state information 410 published to the shared memory 405. This redundant FuSa memory allows the SoC to continue functioning and reconstruct operational context in the event of a malfunction or shutdown of the central chiplet 402. To facilitate this redundancy, the chiplets 450 are interconnected using a communication fabric represented by inter-chiplet path 480. In case of central chiplet 402 failures, the chiplets can exchange state information and control signals over the inter-chiplet path 480, allowing the system to reconstruct task scheduling and maintain autonomous operation even when the central chiplet is turned off by its associated eFuses. In corresponding implementations, processors 430b of the backup SoC 460 can be maintained in a low-power state or activated based on operational role.

In various examples, the shared memory 405 can include a functional safety (FuSa) program 420 that performs health monitoring and error management operations for the primary SoC 400 as well as the backup SoC 460. Likewise, the backup SoC 460 can also include a set of chiplets and a central chiplet with a shared memory (or cache) in which the components of the backup SoC 460 publish state information. The central chiplet of the backup SoC 460 can further include FuSa components for performing health monitoring and error management tasks for the backup SoC 460, as well as having direct memory access to the state information 410 of the primary SoC 400. In certain examples, the FuSa components can include a dedicated FuSa processor 435 to execute the FuSa program 420 and perform the health monitoring and error management functions described throughout the present disclosure.

In various implementations, the functional safety (FuSa) program 420 of the primary SoC 400 can access the shared memory of the backup SoC 460 to dynamically read the state information of the backup SoC 460. In further implementations, the FuSa program 420b of the backup SoC 460 can access and dynamically read the state information 410 in the shared memory 405 of the primary SoC 400. When a triggering event occurs (e.g., a fault or failure), as detected in the state information 410 by the FuSa program of the backup SoC 460, the backup SoC 460 can take over the set of tasks being performed by the primary SoC 400. Thereafter, the primary SoC 400 may reboot or reset the component(s) experiencing the fault or failure, or can reboot or reset the primary SoC 400 itself, and assumes the role of backup SoC 460. In some implementations, chiplets 470 represent one or more computational components configured to process state information and support functional safety operations within the system.

In such implementations, the primary SoC 400 can power down the chiplets 450 and/or the processors 430 of the central chiplet 402 and can maintain the powered-up state for the functional safety (FuSa) processor 435 to execute the FuSa program 420 and monitor the state information published by the SoC 460 in its own shared memory or cache. With the addition of FuSa memory 445b and inter-chiplet communication via the inter-chiplet path 480, the system retains the ability to operate even in the absence of a functional central chiplet, enabling reconstruction of the execution schedule from distributed state information. Accordingly, in autonomous applications, the autonomous tasks previously performed by the primary SoC 400, can be seamlessly transferred to the backup SoC 460 when the triggering event in the state information 410 is detected by the backup SoC 460.

In further embodiments, each time the SoCs (400, 460) are rebooted, they can switch between the role of primary SoC and backup SoC to provide substantially even wear of the hardware components of each SoC 400, 460. It is contemplated that the arrangements shown with respect to FIGS. 2, 3, and 4 can increase the wear life of the SoCs, provide redundancy to increase reliability in performing the set of tasks, and therefore provide an increased safety integrity rating (e.g., ASIL rating) for the SoC arrangement, as well as the autonomous driving system of the vehicle. It is further contemplated that for autonomous drive systems to operate on public roads, an ASIL-D rating may be necessary, and the arrangements and embodiments described throughout the present disclosure can advance the autonomous drive system in terms of safety and integrity to facilitate achieving this rating.

FIG. 5 and FIG. 6 are flow charts describing methods of implementing duplicated status and shadowing for multiple SoCs, according to examples described herein. In the below descriptions of the methods of FIGS. 5 and 6, reference may be made to reference characters representing certain features described with respect to the systems diagrams of FIGS. 1 through 4. Furthermore, the steps described with respect to the flow charts of FIGS. 5 and 6 may be performed by the computing systems 100, 200 and multiple Systems-on-Chip (mSoC) arrangements as shown and described with respect to FIGS. 1 through 4. Further still, certain steps described with respect to the flow charts of FIGS. 5 and 6 may be performed prior to, in conjunction with, or subsequent to any other step, and need not be performed in the respective sequences shown.

Referring to FIG. 5, at block 500, in a first SoC 210 of a multiple Systems-on-Chip (mSoC) arrangement, perform a set of computational tasks. At block 505, the first SoC 210 publishes state information corresponding to the set of tasks in the first memory 215 of the first SoC 210. In some implementations, the set of tasks can comprise any computer tasks performed by the first SoC 210 (primary SoC) in a dual SoC arrangement, such as application-based tasks, enterprise software tasks, computer security tasks, and the like. In accordance with examples described herein, the set of tasks can comprise a set of autonomous driving tasks for an autonomous or semi-autonomous vehicle. These tasks can comprise sensor data processing tasks, such as perception, inference, object detection and/or classification, right-of-way determination, occupancy grid determination, motion prediction, motion planning, and/or vehicle control tasks for the autonomous system.

At block 510, in a second SoC 220 of the dual SoC arrangement, continuously read the first memory 215 of the first SoC 210 to determine the state of the first SoC 210. At block 515, the second SoC 220 can further maintain a plurality of computational components in a low powered state. As provided herein, the plurality of computational components can comprise the various chiplets required to perform the set of tasks currently being performed by the first SoC 210. In the context of FIG. 3, these chiplets can correspond to one or more of the HBM-RAM chiplet 335, autonomous drive chiplet 340, general compute chiplets 345, machine learning (ML) accelerator chiplet 350, and HBM-RAM chiplet 355. In further implementations, certain components of the central chiplet 320 (e.g., one or more CPUs) can also be maintained in a low power state. As provided herein, the low power state can comprise a standby state in which the chiplets are warmed up and ready to take over the set of tasks at any given moment.

At block 520, the second SoC 220 can detect a trigger in the first memory 215 of the first SoC 210. The trigger can correspond to any fault, failure, or other error published by the first SoC 210 in the first memory 215, or otherwise detected by the second SoC 220 via monitoring the first memory 215 of the first SoC 210. Such faults, failures, or errors can correspond to hardware faults or failures in the first SoC 210, temperature thresholds being exceeded, software glitches or other software faults, and the like. Upon detecting the trigger, at block 525, the second SoC 220 can power up the plurality of computational components and take over the set of tasks from the first SoC 210.

FIG. 6 is a flow chart describing a further method of implementing duplicated status and shadowing for a dual SoC arrangement, in accordance with examples described herein. In the below description of FIG. 6, reference may be made to the SoC 300, primary SoC 400, and backup SoC 460 as the primary or backup SoC in the dual SoC arrangement. Referring to FIG. 6, at block 600, a first SoC 400 can receive sensor data from a set of autonomous system sensors or vehicle sensors 305. At block 605, the first SoC 400 can perform a set of autonomous tasks based on the sensor data. For example, the first SoC 400 can include a set of chiplets, as shown in FIG. 3, that each perform one or more autonomous tasks that include one or more perception, inference, object detection and/or classification, right-of-way determination, occupancy grid determination, motion prediction, motion planning, and/or control tasks for the autonomous system. In certain examples, the autonomous system tasks can comprise sensor data perception and inference tasks for autonomously operating a vehicle along a travel route. At block 610, the first SoC 400 can further publish state information 410 in a shared memory 405 of the first SoC 400.

At block 615, the first SoC 400 can further continuously read state information of the second SoC 460. For example, the state information of the second SoC 460 can indicate the operating parameters of the various computational components (e.g., chiplets) of the second SoC 460 in the low powered state and can further indicate whether these components are operating within those parameters (e.g., whether the components are warmed up and ready to take over the set of autonomous tasks). At decision block 620, the first SoC 400 can dynamically determine whether a trigger has been detected in the state information of the second SoC 460. As provided herein, the trigger can correspond to any of the components of the second SoC 460 operating outside nominal parameters, or a fault, failure, or error experienced by the second SoC 460. If no trigger is detected, then the first SoC 400 can continue monitoring the state information of the second SoC 460. However, if at any time a trigger is detected, then at block 625, the first SoC 400 can, for example, transmit a command to the second SoC 460 to cause the second SoC 460 to perform a system reboot. As described herein, information communicated between the primary SoC 400 and the backup SoC 460 can be transmitted via a robust, ASIL-D rated interconnect (e.g., interconnect 240 shown in FIG. 2) using an error correction code (ECC), which provides redundancy algorithmically (e.g., through use of block codes, convolutional codes, and the like).

At block 630, the second SoC 460 can maintain a plurality of computational components in a low power state. As described above, these components can include any one or more of the chiplets as shown and described with respect to FIG. 3. At block 635, the second SoC 460 can continuously read the state information 410 as published by the first SoC 400. At decision block 640, the second SoC 460 can determine whether a trigger is detected in the state information 410. As provided herein, the trigger can correspond to the first SoC 400 experiencing a fault or a failure, where the fault or the failure can correspond to the first SoC 400 experiencing degraded performance, such as overheating, a power surge, or an error in the first SoC 400. If no trigger is detected, then the second SoC 460 can continue to monitor the state information 410 of the first SoC 400. However, if a trigger is detected at any time, at block 645, the second SoC 460 can power up its computational components and take over the set of autonomous driving tasks from the first SoC 400, while the first SoC 400 powers down its components and assumes the role of backup SoC.

At block 650, the second SoC 460 can continue to read the state information 410 of the first SoC 400. At decision block 660, the second SoC 460 can determine whether the first SoC 400 is still degraded. If so, at block 665, the second SoC 460 can initiate a set of mitigative or emergency measures. In certain aspects, these measures can comprise reducing the speed of the vehicle, providing a notification to any passengers in the vehicle (e.g., to take over manual control of the vehicle), autonomously operating the vehicle to a safe location (e.g., pulling over the vehicle or driving to a home location), and/or autonomously operating the vehicle to a service center to resolve the degraded status of the first SoC 400.

In some examples, at block 670, the second SoC 460 may further transmit a command to cause the first SoC 400 to perform a system reboot. At block 655, the first SoC 400 may then perform the backup SoC tasks, such as maintaining a subset of its components in a low power state and dynamically monitoring state information as published by the primary SoC 460. If at any time, the primary and secondary SoCs are unable to communicate (e.g., one of the SoCs is unable to boot up), the autonomous system will not engage. For example, it is contemplated that this arrangement provides necessary redundancy for an increased ASIL rating of the autonomous drive system of the vehicle (e.g., contributes to an ASIL-D rating).

In various examples, each time the multiple Systems-on-Chip (mSoC) arrangement reboots, the first SoC 400 and the second SoC 460 can switch between primary and backup roles to maintain substantially improved even wear on the mSoC components, such as the various chiplets of each SoC. Furthermore, the SoCs can be electrically coupled via one or more eFuses that protect the SoCs from each other (e.g., from voltage or current surges). Along these lines, the first SoC 400 and the second SoC 460 can be powered by distinct power sources, such as the battery pack used for propulsion of the vehicle, and the auxiliary power source of the autonomous system used for powering the auxiliary components (e.g., ECU, lights, radio, etc.).

As provided herein, the state information monitoring and error management functions performed by the first and second SoCs (400, 460) can be performed by functional safety components of each SoC, as shown in FIG. 4 (e.g., the functional safety (FuSa) program 420 and FuSa processor 435). As further provided herein, for the backup SoC, the FuSa components remain powered up to perform their functional safety tasks while the remaining components are maintained in the low power state, and ready to assume the primary SoC tasks. It is contemplated that the first SoC 400 and the second SoC 460 being arranged to dynamically read state information and take over the set of tasks of the primary SoC, providing redundancy to facilitate the necessary safety and integrity certification ratings for the autonomous computing system (e.g., achieve an ASIL-D rating for autonomous drive computing).

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

In accordance with FIG. 6, the computing system includes a process for chiplet-level health assessment and adaptive workload redistribution in degraded conditions. Specifically, in block 601, the primary SoC performs continuous health diagnostics on each of its chiplets using embedded telemetry data, error counters, and thermal/power sensors. If a fault or anomaly is detected, the chiplet raises an error condition, publishing this to the central mailbox (602). The mailbox entry is processed by the FuSa logic, which evaluates the nature of the fault and performs a localized health assessment (603) to determine the severity and persistence of the anomaly. If the issue is confirmed, control logic at block 685 activates an eFuse interface specific to the affected chiplet. This interface allows selective isolation, from disabling specific power rails (e.g., for memory, logic, or interconnect) to fully powering down the chiplet. The system maintains dual-bit safety control on the eFuse trigger path to ensure that disabling the chiplet does not propagate electrical instabilities. In response to the chiplet being disabled, block 686 loads a precompiled semaphore graph from local memory or the FuSa memory segment. This graph defines a degraded execution path by redistributing tasks of the failed chiplet to other available resources, for example, other chiplets with overlapping capability. The semaphore graph orchestrates task handoffs and synchronization between chiplets, preserving functional safety guarantees while adapting to the partial failure. This degraded mode maintains the system's ability to perform critical tasks until a full recovery, SoC reboot, or repair is initiated.

As illustrated in FIG. 6 and expanded herein, each SoC in the mSoC arrangement includes a subsystem that continuously reads the memory and state information published by its paired SoC. This includes, but is not limited to, task scheduling metadata, runtime duration logs, and thermal or current telemetry associated with active chiplets. This subsystem supports a cross-checking mechanism for run-time verification and execution integrity across SoCs. When a mismatch is detected, such as a deviation in expected execution time for a scheduled workload or inconsistency in resource usage, the detecting SoC analyzes this through its internal mailbox logic 666 and determines whether the paired SoC may be entering a degraded or faulty state. Upon confirming the inconsistency, the detecting SoC initiates a remote degradation trigger, causing the paired SoC to prepare for safe-mode execution. As part of this process, block 668 loads a degraded task scheme, a precompiled semaphore-based execution graph that reduces computational load or reassigns critical tasks, and writes it into a diagnosed safe memory area on the paired SoC. This memory region is isolated for functional safety purposes and is continuously monitored to ensure the safe continuation of critical operations. This bilateral supervision and enforcement loop ensures that even if one SoC fails to self-diagnose, the paired SoC can act as a watchdog and enforce a degradation path. This distributed integrity checking mechanism further enhances the architecture's compliance with ASIL-D or DO-254 requirements and reinforces mission-critical reliability under partial system failure conditions.

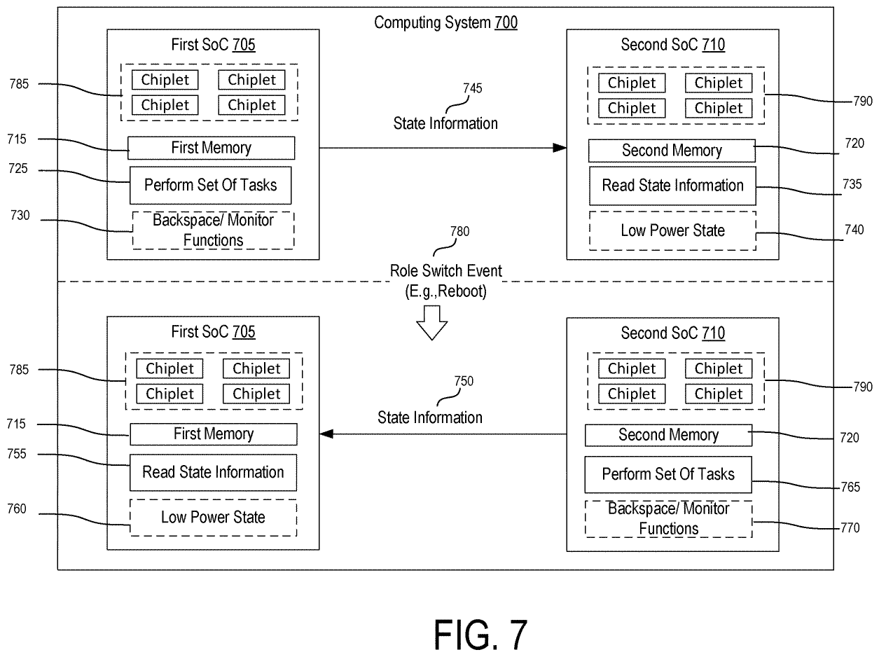

Referring to FIG. 7, FIG. 7 is a block diagram illustrating role switching in a computing system 700 between the first SoC and the second SoC, in accordance with examples described herein. The computing system 700 includes a first system-on-chip (SoC) 705 and a second SoC 710.

In a first operational configuration, the first SoC 705 includes a first memory 715 and is configured to operate, Perform Set Of Tasks 725. The operation, Perform Set Of Tasks 725 corresponds to execution of a set of tasks using computational components of the first SoC 705. In some embodiments, the set of tasks comprises autonomous system tasks, including sensor data processing, inference, scene understanding, object detection and classification, motion prediction of dynamic external agents, and motion planning and execution to operate a system along a trajectory.

The first SoC 705 further includes backspace/monitor functions 730. The backspace/monitor functions 730 correspond to monitoring and auxiliary operations performed by the first SoC 705 during execution of the set of tasks. In some embodiments, the backspace/monitor functions 730 include monitoring operational status, including fault conditions, power conditions, and error conditions. In some embodiments, the backspace/monitor functions 730 operate concurrently with the operation, Perform Set Of Tasks 725.

The first SoC 705 includes a plurality of computational components 785, and the second SoC 710 includes a plurality of computational components 790. The plurality of computational components for each SoC comprise chiplets of the respective SoCs. Each chiplet performs a portion of the set of tasks and may include sensor processing, inference, or control operations. The chiplets operate together to perform the set of tasks.

The set of tasks performed by the first SoC 705 and the second SoC 710 are carried out by the respective plurality of computational components. The chiplets read and write state information using the first memory 715 and the second memory 720. The state information reflects current execution of the set of tasks across the chiplets. During role switching, the SoC that takes over does not activate all of its chiplets at once. The SoC activates one or more chiplets of the plurality of computational components that are needed to perform the set of tasks. The activated chiplets use the state information read from the other SoC to begin operation. Other chiplets of the plurality of computational components may remain in a low power state.

The state information provides the current working data for the set of tasks. The chiplets use that state information to continue execution from the point at which the other SoC stopped. The set of tasks proceeds based on the state information, and the set of tasks is not restarted from an initial state.

In the first operational configuration, the second SoC 710 includes a second memory 720 and is configured to read state information 735. The operation “read state information” 735 corresponds to the second SoC 710 accessing and reading state information from the first memory 715 of the first SoC 705. In some embodiments, the read state information 735 operation includes dynamically reading state information corresponding to execution of the set of tasks by the first SoC 705.

The second SoC 710 further maintains a low power state 740. In some embodiments, the low power state 740 corresponds to maintaining at least a subset of computational components of the second SoC 710 in a low power state while performing the Read State Information 735 operation. The second SoC 710 maintains readiness to perform the set of tasks based on the state information read from the first SoC 705.

In the first operational configuration, the first SoC 705 publishes state information 745 corresponding to execution of the set of tasks. In some embodiments, the state information 745 includes task context, registers or queues, model or algorithm states, environment statistics, and health or status information associated with execution of the set of tasks. The state information 745 is communicated from the first SoC 705 to the second SoC 710, and the second SoC 710 performs the read state information 735 operation.

The computing system 700 further includes a role switch event 780 (e.g., reboot), which transitions the computing system 700 from the first operational configuration to a second operational configuration. In one example, the role switch event 780 may correspond to a reboot of the computing system 700 or another operational event that causes switching of roles between the first SoC 705 and the second SoC 710.

In the second operational configuration, the second SoC 710 includes the second memory 720 and is configured to perform set of tasks 765. The operation, Perform Set Of Tasks 765, corresponds to execution of the set of tasks using computational components of the second SoC 710.

The second SoC 710 further includes backspace/monitor functions 770. In this configuration, the backspace/monitor functions 770 correspond to monitoring operations performed by the second SoC 710 during execution of the set of tasks, including monitoring of operational status and system conditions.

In the second operational configuration, the first SoC 705 includes the first memory 715 and is configured to read state information 755. The operation Read State Information 755 corresponds to the first SoC 705, accessing and reading state information 750 from the second memory 720 of the second SoC 710.

The first SoC 705 further maintains a low power state 760. In some embodiments, the low power state 760 corresponds to maintaining at least a subset of computational components of the first SoC 705 in a low power state while performing the Read State Information 755 operation.

In the second operational configuration, the second SoC 710 publishes state information 750 corresponding to execution of the set of tasks. The State Information 750 is communicated from the second SoC 710 to the first SoC 705, and the first SoC 705 performs the Read State Information 755 operation.

Accordingly, the first SoC 705 and the second SoC 710 are configured to switch roles with respect to execution of the set of tasks and access to state information. In the first operational configuration, the first SoC 705 performs set of asks while the second SoC 710 reads state information, and in the second operational configuration, the second SoC 710 performs set of asks while the first SoC 705 reads state information.

In some embodiments, during each operational configuration, the SoC performing the set of tasks publishes state information, and the other SoC performs the corresponding “Read State Information” operation while maintaining the corresponding low power state. The SoC in the low power state maintains readiness to perform the set of tasks based on the state information read from the other SoC.

In some embodiments, the role switch event 780 (e.g., reboot) occurs each time the computing system 700 is rebooted, such that the first SoC 705 and the second SoC 710 alternate roles between performing the set of tasks and reading state information. This role switching enables the computing system 700 to maintain continuity in execution of the set of tasks while distributing execution responsibilities between the first SoC 705 and the second SoC 710.

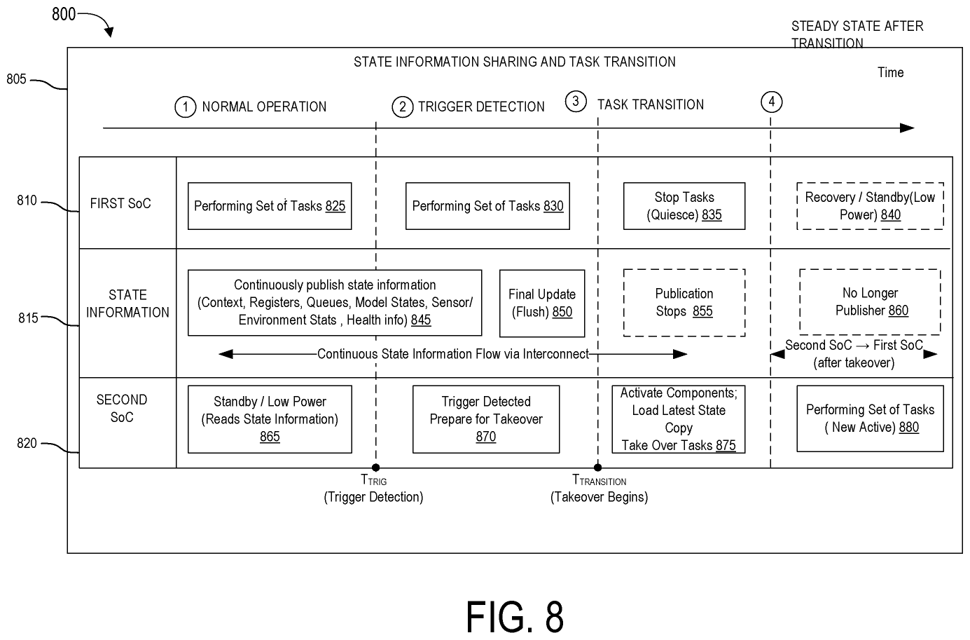

Referring to FIG. 8, FIG. 8 is a diagram 800 illustrating state information sharing and transition of execution of a set of tasks from the first SoC to the second SoC, in accordance with examples described herein. The diagram 800 represents operation over time and shows how one SoC performs a set of tasks while another SoC maintains readiness to take over the set of tasks. The diagram also shows how state information is continuously exchanged, allowing the second SoC to assume control without recomputing prior operations or reconstructing the execution context.

FIG. 8 illustrates state information sharing and task transition 805 between the first SoC 810 and the second SoC 820 over time, including the state information 815 published by the publishing SoC and read by the reading SoC. The diagram further illustrates a sequence of phases that occur during normal operation, detection of a trigger, transition of execution, and operation after the transition. The phases include normal operation, trigger detection, task transition, and steady state after transition. The diagram also identifies timing points, including TTRIG and TTRANSITION, which correspond to the detection of a trigger and initiation of the transition. The diagram shows continuous publication of state information at 845 by the first SoC 810 during normal operation, followed by a final update 850 and cessation of publication at 855 during the transition. The diagram further shows that execution of the set of tasks transfers from performing set of tasks at 825 by the first SoC 810 to performing set of tasks (new active) at 880 by the second SoC 820, and that control shifts between the first SoC 810 and the second SoC 820 while maintaining continuity of operation.

The first SoC 810 and the second SoC 820 each include a plurality of computational components that comprise chiplets. The chiplets perform the set of tasks and use the state information described in FIG. 8. During operation, the chiplets read and write the state information through the corresponding memory. The state information reflects current execution of the set of tasks across the chiplets. During task transition, the SoC that takes over activates one or more chiplets to perform the set of tasks. The activated chiplets use the state information, including the final update, to begin operation. Other chiplets may remain in a low power state. The set of tasks continues based on the state information without restarting the set of tasks.

During normal operation, the first SoC 810 performs set of tasks at 825 while the second SoC 820 remains in standby/low power 865. The first SoC 810 performs “continuously publishes state information” at 845, where the state information 815 includes context, registers, queues, model states, sensor or environment statistics, and health information. The second SoC 820 reads the state information 815 and maintains a current copy of execution state while not actively performing the set of tasks. The diagram shows continuous state information flow via the interconnect between the first SoC 810 and the second SoC 820 during normal operation. The second SoC 820 monitors the current working data of the first SoC 810 without performing the same computations. The architecture differs from lockstep execution or checkpointing because the state information 815 remains current and available for immediate use rather than being reconstructed after a failure.

At trigger detection, a trigger is identified at time T_{TRIG}. The trigger may correspond to a fault, failure, or lack of response from the first SoC 810. The first SoC 810 continues the operation, performing set of tasks at 830 during the trigger detection phase. The state information 815 remains available throughout. The second SoC 820 prepares for takeover at 870 in response to the trigger. Preparing for a takeover may include several actions. The second SoC 820 may copy the latest model state and environment statistics from memory into working memory. The second SoC 820 may initialize execution threads using the copied state. The second SoC 820 may perform a quick health check on its own components to confirm readiness. The second SoC 820 may prepare control outputs so that commands can be issued without delay.

At the start of the transition at time T_{TRANSITION}, the first SoC 810 performs the stop-tasks operation (quiesce) at 835 and performs a final update (flush) at 850 so that the most recent execution state is published. Publication then stops at 855, and the first SoC 810 is no longer a publisher as depicted at 860.

During task transition, the second SoC 820 activates components, loads the latest state copy, and proceeds to take over tasks at 875. The second SoC 820 then performs set of tasks at 880. The second SoC 820 continues execution from the latest state provided by the block “Continuously publish state information” at 845 and the “final update” block at 850, rather than restarting the set of tasks. The handoff from the first SoC 810 to the second SoC 820 occurs without restarting tasks or reloading working state, reducing transition delay relative to systems that restart or reload after a failure.

During steady state after transition, the second SoC 820 continues performing set of tasks at 880 while the first SoC 810 transitions to recovery/standby (low power) 840 and reads state information from the second SoC 820. After the takeover, the direction of communication changes. The second SoC 820 now performs the set of tasks and begins publishing state information, and the first SoC 810 reads that state information over the interconnect. The diagram shows continuous state information flow via interconnect from the second SoC 820 to the first SoC 810 after takeover. The first SoC 810 no longer performs the set of tasks and instead moves into recovery/standby (low power) 840. In that role, the first SoC 810 reads the same type of state information 815 that the second SoC 820 previously read, including context, queues, and current results.

The first SoC may have experienced a fault such as overheating, a transient error, or a temporary power condition. After the takeover, the first SoC can reset or reboot its components while the second SoC continues operation. Once the first SoC returns to normal operation, it remains in the standby role and continues reading state information so that it maintains an up-to-date copy of the working data. The first SoC is then ready to take over again if another trigger occurs.

The system is set up so that either SoC can recover and return to service. The roles can switch back and forth as needed, whether due to a temporary fault, a reset event, or a planned role change. Each switch follows the same pattern of publishing state information, detecting a trigger, and handing off control. The system continues running without stopping because one SoC always performs the set of tasks while the other SoC tracks the current state and remains ready to take over.

A computing system includes a first system on a chip (SoC) comprising a first memory, the first SoC configured to publish, in the first memory, state information corresponding to a set of tasks being performed by the first SoC, the first SoC comprising a first plurality of computational components; and a second SoC comprising a second memory and a second plurality of computational components, the second SoC having memory access to the first memory to dynamically read the state information published by the first SoC. The second SoC is configured to maintain a subset of the second plurality of computational components in a low power state. When the second SoC detects a trigger while reading the state information published in the first memory, the second SoC is configured to activate the subset of the second plurality of computational components to perform the set of tasks. Each time the computing system is rebooted, the first SoC and the second SoC are configured to switch roles in performing the set of tasks and placing a subset of the corresponding plurality of computational components in the low power state and dynamically reading published state information from the first SoC or second SoC. The set of tasks may comprise autonomous tasks, the autonomous tasks comprising sensor data perception and inference tasks for autonomously operating a system along a trajectory. The trigger may correspond to the first SoC experiencing a fault or a failure, the fault or the failure corresponding to the first SoC overheating, a power surge, or an error in the first SoC. The first SoC may be powered by a first power source of a system, and the second SoC may be powered by a second power source of the system, where the first power source comprises a battery pack used for propulsion of the system and the second power source comprises an auxiliary power source of the system. The first SoC and the second SoC may be electrically coupled to each other via an interconnect having at least one electrical safety switch to protect the computing system from power surges from either the first SoC or the second SoC. The first SoC may dynamically read the second memory of the second SoC to determine whether the second SoC is ready to perform the set of tasks being performed by the first SoC. The first SoC and the second SoC may be arranged to dynamically read the state information and perform the set of tasks, providing redundancy to facilitate a safety and integrity certification for the computing system, wherein the integrity certification comprises an automotive safety integrity level (ASIL) rating for autonomous drive computing.

The first plurality of computational components and the second plurality of computational components may comprise chiplets of each of the first SoC and the second SoC, wherein the subset of the second plurality of computational components in a low power state comprises one or more of general compute chiplets, autonomous drive chiplets, machine learning (ML) accelerator chiplets, sensor input chiplets, and high bandwidth memory chiplets. Each of the first plurality of computational components and the second plurality of computational components may include a functional safety (FuSa) CPU that publishes state information of the first SoC and the second SoC to a FuSa component of the first memory and the second memory respectively, wherein the first SoC and the second SoC are configured to maintain the FuSa CPU outside the low power state. When the second SoC performs the set of tasks of the first SoC, the first SoC may reset or reboot the first plurality of computational components. Each chiplet of the first plurality of computational components and the second plurality of computational components may include a FuSa memory segment configured to store local state information, wherein the computing system is configured to continue operating in a degraded mode when one or more chiplets become non-functional and the respective SoC is configured to perform the set of tasks with one or more fewer chiplets. Each SoC may comprise hardware circuitry configured to control and monitor internal voltage regulation and power distribution, wherein the SoC is configured to measure current and voltage delivered to each chiplet and isolate and power off individual chiplets by triggering an electrical fuse (eFuse) through a dual-bit functional safety (FuSa) control line for safe disconnection under fault conditions. Each SoC may comprise a scheduler configured to adapt to a degradation event by recalculating the set of tasks to be performed based on availability of functional chiplets for continued operation at a reduced processing capacity while maintaining functional safety guarantees.

The first SoC may be configured to perform individual health diagnostics of each chiplet, detect error conditions published to a mailbox, and in response to a fault in a chiplet, execute a degradation path comprising configuring an eFuse control mechanism to selectively disable one or more power rails associated with a faulty chiplet and loading a preconfigured semaphore graph that redistributes workload of the faulty chiplet across remaining operational chiplets. Each of the first SoC and the second SoC may be configured with per-chiplet diagnostic logic, eFuse control circuitry, and preconfigured semaphore graphs, wherein either SoC, when operating in a primary role, is configured to isolate a degraded chiplet and dynamically reconfigure workload across remaining operational chiplets to maintain functional safety and system availability in a degraded execution mode. The first SoC and the second SoC may be configured to achieve an automotive safety integrity level (ASIL-D) rating, with presence of per-chiplet eFuse protection circuitry configured to isolate chiplets in response to electrical anomalies. Each of the first SoC and the second SoC may comprise a subsystem configured to continuously monitor operational status and workload performance of corresponding paired SoC, and in response to detection of a discrepancy based on mailbox analysis indicating mismatched scheduling or unexpected runtime behavior, the monitoring SoC is configured to initiate a remote degradation process on the paired SoC by triggering a diagnostic degradation mode, loading a degraded execution scheme, and storing said scheme in a predefined safe memory area of the paired SoC for execution under functional safety constraints.

A computing system includes a first system on a chip (SoC) comprising a first memory, the first SoC configured to publish, in the first memory, state information corresponding to a set of tasks performed by the first SoC, the first SoC comprising a first plurality of computational components, wherein the state information comprises statistical information corresponding to a surrounding environment of a vehicle in which the computing system resides; and a second SoC comprising a second memory and a second plurality of computational components, the second SoC having memory access to the first memory to dynamically read the state information published by the first SoC. The second SoC maintains a subset of the second plurality of computational components in a low power state. When the second SoC detects a trigger while reading the state information published in the first memory, the second SoC is configured to activate the subset of the second plurality of computational components to perform the set of tasks.

A computer-implemented method includes publishing, by a first system on a chip (SoC) comprising a first memory, state information corresponding to a set of tasks being performed by the first SoC in the first memory, the first SoC comprising a first plurality of computational components, wherein the state information comprises statistical information corresponding to a surrounding environment of a system in which the computing system resides; accessing, by a second SoC comprising a second memory and a second plurality of computational components, the first memory to dynamically read the state information published by the first SoC, wherein the second SoC maintains a subset of the second plurality of computational components in a low power state; detecting, by the second SoC, a trigger based on the state information published in the first memory; and activating, by the second SoC, in response to detecting the trigger, the subset of the second plurality of computational components to perform the set of tasks of the first SoC. The set of tasks may comprise autonomous tasks, the autonomous tasks comprising sensor data perception and inference tasks for autonomously operating a system along a trajectory.

Many variations may be made to the embodiments described herein. All variations, including combinations of embodiments, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A computing system comprising:
a first system on a chip (SoC) comprising a first memory, the first SoC configured to publish, in the first memory, state information corresponding to a set of tasks being performed by the first SoC, the first SoC comprising a first plurality of computational components; and
a second SoC comprising a second memory and a second plurality of computational components, the second SoC having memory access to the first memory to dynamically read the state information published by the first SoC, wherein the second SoC configured to maintain a subset of the second plurality of computational components in a low power state;
wherein, when the second SoC detects a trigger while reading the state information published in the first memory, the second SoC is configured to activate the subset of the second plurality of computational components to perform the set of tasks;
wherein each time the computing system is rebooted, the first SoC and the second SoC are configured to switch roles in:
performing the set of tasks; and
placing a subset of the corresponding plurality of computational components in the low power state and dynamically reading published state information from the first SoC or the second SoC.

2. The computing system of claim 1, wherein the set of tasks comprises autonomous tasks, the autonomous tasks comprising sensor data perception and inference tasks for autonomously operating a system along a trajectory.

3. The computing system of claim 1, wherein the trigger corresponds to the first SoC experiencing a fault or a failure, the fault or the failure corresponding to first SoC overheating, a power surge, or an error in the first SoC.

4. The computing system of claim 1, wherein the first SoC is powered by a first power source of a system, and the second SoC is powered by a second power source of the system;
wherein the first power source comprises a battery pack used for propulsion of the system, and the second power source comprises an auxiliary power source of the system.

5. The computing system of claim 1, wherein the first SoC and the second SoC are electrically coupled to each other via an interconnect having at least one electrical safety switch to protect the computing system from power surges from either the first SoC or the second SoC.

6. The computing system of claim 1, wherein the first SoC dynamically reads the second memory of the second SoC to determine whether the second SoC is ready to perform the set of tasks being performed by the first SoC.

7. The computing system of claim 1, wherein the first SoC and the second SoC are arranged to dynamically read the state information and perform the set of tasks, providing redundancy to facilitate a safety and integrity certification for the computing system;
wherein the integrity certification comprises an automotive safety integrity level (ASIL) rating for autonomous drive computing.

8. The computing system of claim 1, wherein the first plurality of computational components and the second plurality of computational components comprise chiplets of each of the first SoC and the second SoC;
wherein the subset of the second plurality of computational components in the low power state comprises one or more of general compute chiplets, autonomous drive chiplets, machine learning (ML) accelerator chiplets, sensor input chiplets, and high bandwidth memory chiplets.

9. The computing system of claim 8, wherein each of the first plurality of computational components and the second plurality of computational components includes a functional safety (FuSa) CPU that publishes the state information of the first SoC and the second SoC to a FuSa component of the first memory and the second memory respectively;
wherein the first SoC and the second SoC are configured to maintain the FuSa CPU outside the low power state.

10. The computing system of claim 1, wherein when the second SoC performs the set of tasks of the first SoC, the first SoC resets or reboots the first plurality of computational components.

11. The computing system of claim 1, wherein each chiplet of the first plurality of computational components and the second plurality of computational components includes a FuSa memory segment configured to store local state information;
wherein the computing system is configured to continue operating in a degraded mode when one or more chiplets become non-functional and the corresponding SoC is configured to perform the set of tasks with one or more fewer chiplets.

12. The computing system of claim 1, wherein each SoC comprises hardware circuitry configured to control and monitor internal voltage regulation and power distribution, wherein the SoC is configured to measures current and voltage delivered to each chiplet and isolate and power off individual chiplets by triggering an electrical fuse (eFuse) through a dual-bit functional safety (FuSa) control line for safe disconnection under fault conditions.

13. The computing system of claim 1, wherein each SoC comprises a scheduler configured to adapt to a degradation event by recalculating the set of tasks to be performed based on availability of functional chiplets for a continued operation at a reduced processing capacity while maintaining functional safety guarantees.

14. The computing system of claim 1, wherein the first SoC is configured to:
perform individual health diagnostics of each chiplet;
detect error conditions published to a mailbox; and
in response to a fault in a chiplet, execute a degradation path comprising:
configuring an eFuse control mechanism to selectively disable one or more power rails associated with a faulty chiplet; and
loading a preconfigured semaphore graph that redistributes workload of the faulty chiplet across remaining operational chiplets.

15. The computing system of claim 1, wherein each of the first SoC and the second SoC is configured with per-chiplet diagnostic logic, eFuse control circuitry, and preconfigured semaphore graphs, wherein either SoC, when operating in a primary role, is configured to isolate a degraded chiplet and dynamically reconfigure workload across remaining operational chiplets to maintain functional safety and system availability in a degraded execution mode.

16. The computing system of claim 1, wherein the first SoC and the second SoC are configured to achieve an automotive safety integrity level (ASIL-D) rating, with presence of per-chiplet eFuse protection circuitry configured to isolate chiplets in response to electrical anomalies.

17. The computing system of claim 1, wherein each of the first SoC and the second SoC comprises a subsystem configured to continuously monitor operational status and workload performance of corresponding paired SoC;
wherein, in response to detection of a discrepancy based on mailbox analysis indicating mismatched scheduling or unexpected runtime behavior, the monitoring SoC is configured to initiate a remote degradation process on the paired SoC by:
triggering a diagnostic degradation mode;
loading a degraded execution scheme; and
storing said scheme in a predefined safe memory area of the paired SoC for execution under functional safety constraints.

18. A computing system comprising:
a first system on a chip (SoC) comprising a first memory, the first SoC configured to publish, in the first memory, state information corresponding to a set of tasks performed by the first SoC, the first SoC comprising a first plurality of computational components, wherein the state information comprises statistical information corresponding to a surrounding environment of a vehicle in which the computing system resides; and
a second SoC comprising a second memory and a second plurality of computational components, the second SoC having memory access to the first memory to dynamically read the state information published by the first SoC, wherein the second SoC maintains a subset of the second plurality of computational components in a low power state,
wherein, when the second SoC detects a trigger while reading the state information published in the first memory, the second SoC is configured to activate the subset of the second plurality of computational components to perform the set of tasks.

19. A computer-implemented method comprising:
publishing, by a first system on a chip (SoC) comprising a first memory, state information corresponding to a set of tasks being performed by the first SoC in the first memory, the first SoC comprising a first plurality of computational components, wherein the state information comprises statistical information corresponding to a surrounding environment of a system in which the computing system resides;
accessing, by a second SoC comprising a second memory and a second plurality of computational components, the first memory to dynamically read the state information published by the first SoC, wherein the second SoC maintains a subset of the second plurality of computational components in a low power state;
detecting, by the second SoC, a trigger based on the state information published in the first memory; and
activating, by the second SoC, in response to detecting the trigger, the subset of the second plurality of computational components to perform the set of tasks of the first SoC.

20. The computer-implemented method of claim 19, wherein the set of tasks comprises autonomous tasks, the autonomous tasks comprising sensor data perception and inference tasks for autonomously operating the system along a trajectory.
